(19) United States
(12) Patent Application Publication
(10) Pub. No.: US 2008/0097916 A1
(43) Pub. Date: Apr. 24, 2008

(54) Method Of Collecting And Distributing Information And Sorting By Bid Price Using Wireless Communication Terminal

(75) Inventor: Wei Shen, Beijing (CN)

Correspondence Address: AKERMAN SENTERFITT, P.O. BOX 3188, WEST PALM BEACH, FL, 33402-3188, US

(73) Assignee: Gmedia Corporation, Grand Cayman (KY)

(21) Appl. No.: 11/722,593

(22) PCT Filed: Oct. 28, 2005
(86) PCT No.: PCT/CN05/01778

§ 371 Date: Jun. 22, 2007

(30) Foreign Application Priority Data
Dec. 24, 2004 (CN) 200410101827.8

(51) Int. Cl. H04K 1/00; G06Q 30/00

(52) U.S. Cl. 705/51

(57) ABSTRACT

The present invention relates to a method of collecting and distributing information and sorting by bid price using wireless communication terminal, to resolve a problem of the prior art that the process of learning information related to advertisements or commodities for a user is cumbersome. The system of the present invention is comprised of: an information inputting system, an information storing system, an information verifying system, a searching system, a sorting system, a replying system, a wireless communication terminal, a barcode identifying system, in which the information inputting system, the information storing system, the information verifying system, the searching system, the sorting system and the replying system may run on a same server or run on different machines separately, and the wireless communication terminal should also include a decoding system, a responding system and a displaying system. The method of the present invention acquires bar code information on an information carrier by the wireless communication terminal, and acquires result information sorted by click payment.

### TECHNICAL FIELD

The present invention relates to a method of collecting and distributing information with wireless communication terminals and a network; especially to a method for obtaining barcode information on carriers and sorting search results according to bid prices using mobile communication terminals.

### BACKGROUND ARTS

Recently, Internet has been widely used, and accessing Internet through a mobile phone is also popularized gradually. People may enjoy a variety of services through Internet, such as shopping, booking hotels, browsing information and so on. Meanwhile, papers, magazines and posters are publishing more and more advertisements with URLs to direct people to access related web pages and acquire more information.

However, to access a network, a user has to perform operations such as inputting URLs on a terminal device and so on. For a mobile phone user, such complicated operations for accessing the network are quite cumbersome. However, for a computer terminal which is relatively convenient for the operation of inputting the URLs, it is often the case that the user does not take along the computer terminal when he is reading the advertisements. Therefore, this would affect the effect of advertising and promoting using URLs.

Due to the development of camera mobile phones, the application of identifying barcodes (including one-dimensional codes, two-dimensional codes and the like) via camera lens of mobile phones and obtaining related information from a network is increasing. That is, to carry barcodes on printed media, identify the barcodes via the camera lens of the mobile phones, and obtain information from the network. Another application is to identify barcodes (for example, EAN barcodes) on commodities by camera lens of mobile phones and obtain information related to the commodities from a database through a network. However, all these applications do not relate to the method for sorting the obtained information, for example, how to sort obtained information (including information such as commodity price, commodity specification, service and introduction of vendor) of multiple vendors after reading a barcode on a commodity.

The patent document [publication number] CN 1462003A discloses a method for distributing information by using search engines and for sorting by bid prices. In the method, an information distributor may input information, and may set search keyword and payment for each click, and then a computer program may distribute the information as a search result for a designated keyword. Pieces of information are sorted by payments for each click, and are continuously re-sorted according to new settings. This method is limited to applications of search engines for Internet, because it is quite cumbersome to input keyword on a mobile terminal, and it is hard to use keywords to replace various of information descriptions (for example, names, categories, makers and so on) expressed by barcodes on commodities.

The patent document [publication number] CN 1321947A discloses a method and a system for quickly discriminating price differences for a same commodity, in which three steps of building a web site, downloading information and discriminating commodity are included. That is, building a web site related to a commodity, which includes prices for this commodity of different stores and other information; connecting a computer terminal to the built web site, and connecting an identifying apparatus to an interface of the computer terminal to download the information on the web site to the identifying apparatus; connecting an external identifying device to an interface of the identifying apparatus, and controlling the identifying device to display desired commodity information on a liquid crystal display of the identifying apparatus. The drawback of this method is that the displayed information is downloaded into the identifying apparatus other than real-time information (for example, commodity price may change momentarily). Additionally, there is no sorting method for the displayed information.

Currently, there is no good solution for the above-mentioned problems. In most cases, in order to get some information related to an advertisement or a commodity, a user has to search using search engines through a computer terminal or a mobile terminal for some amount of fragmentary information, and look for desired information in a large amount of information.

### SUMMARY OF THE INVENTION

The main objective of the present invention is to address the above-mentioned problems by providing a method for acquiring barcode information on an information carrier through a mobile communication terminal and for acquiring results that are sorted according to click payments via a network. With this method, an information distributor may determine the order of information by comprehensively considering factors such as specific objective and propagation requirement of information and the like. A user may conveniently identify barcodes on commodities or advertisements by camera apparatus of wireless communication terminal, and may conveniently and quickly obtain related information desired without overmuch manual information inputting.

The objective of the present invention is achieved by: an information distributor submitting information for distribution which corresponds to barcode information on an information carrier to a storing system through an information inputting system with a wireless communication terminal or a computer terminal; a verifier submitting valid information for distribution to a distributing database through a verifying system; a user translating the barcode information into a search keyword through a decoding system after capturing the barcode information on the information carrier through a wireless communication terminal; and then a responding system on the wireless communication terminal initiating a request for search; in response to the request, a searching system in a server searching the database for information for distribution which conforms to the search condition; the information for distribution which conforms to the condition being sorted by a sorting system, and the sorted result set being sent to the wireless communication terminal through a replying system; the wireless communication terminal displaying the results to the user in a certain fashion. This method utilizes a wireless communication network, and is implemented by a software system set on the server.

The wireless communication network mentioned here refers to not only a mobile communication network, but also a wireless communication network which is based on wireless network cards and wireless base stations (such as those wireless base stations disposed in hotels, stores or at airports) and a user may access the network through the network card installed in or connected to a Palm or a mobile phone.

The system of the present invention is mainly comprised of: an information inputting system, an information storing system, an information verifying system, a searching system, a sorting system, a replying system, a wireless communication terminal, and a barcode identifying system, in which the information inputting system, the information storing system, the information verifying system, the searching system, the sorting system and the replying system may either run on a same server or run independently on separate machines, and the wireless communication terminal should includes a decoding system, a responding system and a displaying system, wherein the decoding system may be a software modular run on the terminal, the responding system is responsible for the communication of the server end, and the displaying system generally refers to a displaying device of the wireless communication terminal.

The present invention includes two steps of distributing and searching, in which the step of information distributing includes:

1. an information distributor submitting information for distribution to a storing system through an information inputting system,

2. verifying through a verification managing system whether the information for distribution corresponds to barcode information and whether the information for distribution conforms to a condition,

3. storing the verified information to a distributing database; and the step of information searching includes:

1. a user obtaining the barcode information on an information carrier through a barcode identifying apparatus on or connected to a wireless communication terminal,

2. translating the barcode information into a search keyword

3. initiating a request for search to a server by the wireless communication terminal,

4. according to the received search keyword, a searching system searching out original data which conforms to the search condition from the distributing database,

5. a sorting system sorting the original data by payments for each click according to a rule set by the sorting system, and generating a sorted result set,

6. the wireless communication terminal receiving the sorted result data, and displaying the results to the user according to a set displaying rule.

### DESCRIPTION OF THE DRAWINGS

The method for collecting and distributing information with wireless communication terminal and for sorting by bid price of the present invention is further described below in connection with figures and embodiments.

FIG. 1 is a system block diagram illustrating the present invention;

FIG. 2 is a representation of one-dimensional barcode patterns in accordance with example 1 of the present invention;

FIG. 3a/3b is a block diagram of an information reading apparatus in accordance with example 1 of the present invention;

FIG. 4 is a flow chart for information distribution in accordance with example 1 of the present invention;

FIG. 5 is a flow chart for information sorting in accordance with example 1 of the present invention;

FIG. 6 is a representation of two-dimensional barcode patterns in accordance with example 2 of the present invention; and

FIG. 7 is a flow chart for information distribution in accordance with example 2 of the present invention

### DETAILED EMBODIMENTS

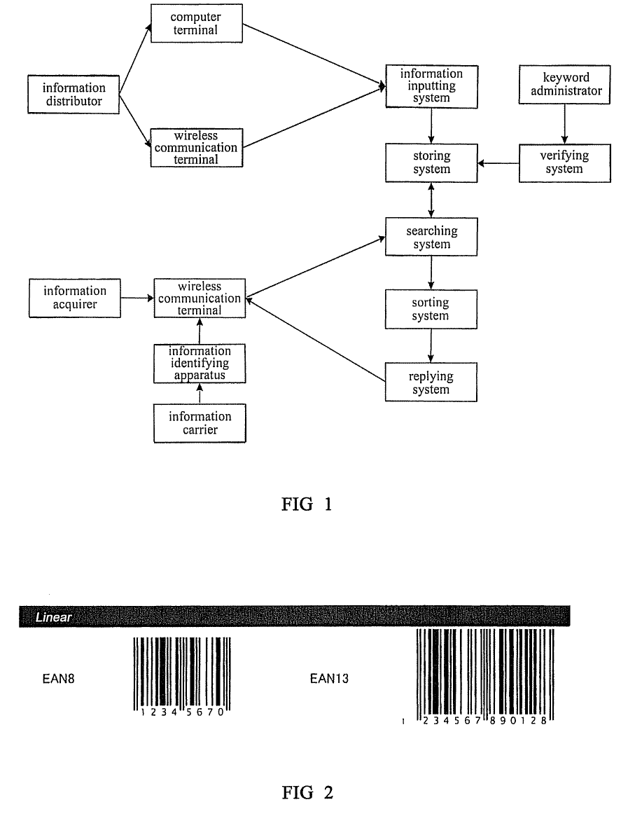

Referring to FIG. 1 to 7.

### Example 1

In a system for collecting and distributing information with wireless communication terminal and for sorting by bid price in accordance with example 1 of the present invention, general commodity barcodes (for example, EAN code) are employed as information carrier.

FIG. 2 shows patterns of EAN general commodity barcode. A barcode may be formed of graphics which is encodable and automatically identifiable. It may be encoded by computer and can be made on a barcode printing device, or it may be generated by outputting electronic files to a lithographing and typesetting device or a film outputting device, and being lithographed and printed in connection with printed matters. The graphic data of a barcode may be read by a photoelectric sensing element such as CCD or CMOS, and may be interpreted to previously compiled data by a decoding apparatus.

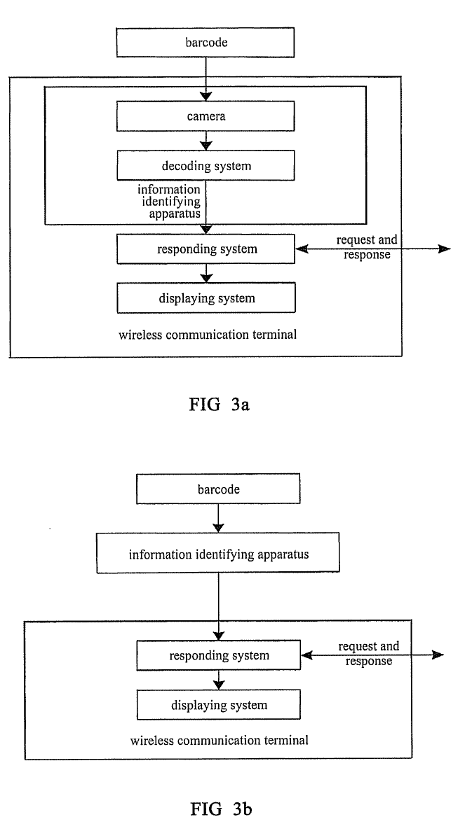

FIG. 3a is a block diagram of an information reading apparatus. A barcode (1) is read by a camera (2) installed in a mobile terminal (6) as graphic information, and is decoded by a decoding system (3). The decoded information is transferred to a calculating apparatus (5) of the mobile terminal (6).

FIG. 3b is a block diagram of another information reading apparatus. A barcode (7) is read as graphic information and decoded by a barcode identifying device (8). The decoded information is transferred to a calculating apparatus (9) of a mobile terminal (10) via wired or wireless link.

In example 1, barcodes printed on commodities or on packaging of commodities are identified by camera apparatus of mobile phones.

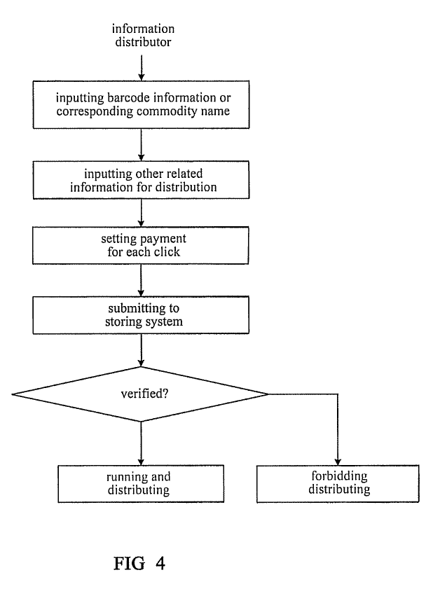

FIG. 4 is a schematic of information distribution. An information distributor A inputs through an information distributing terminal (for example, a networked computer or a mobile phone) the name or barcode information for a commodity, for example, commodity name: Grapefruit Juice of DAHU Brand, barcode information: 690818338989; information for distribution is inputted as: for example, price: [symbol] 8.00 yuan, buy five get one free, free delivery within the fourth ring road of Beijing; and payment for each click or display is set by the information distributor or an administrator as: for example, [symbol] 0.3 yuan for each click to distribute; and then the inputted information is transferred and stored in an information distributing server.

For the commodity with the same barcode, an information distributor B also inputs through an information distributing terminal the commodity name or barcode information, for example, commodity name: Grapefruit Juice of DAHU Brand, barcode information: 690818338989; the information for distribution is: price: [symbol] 7.80 yuan, buy six get one free, raffle promotions for users in Beijing; and payment for each click is set as: [symbol] 0.35 yuan for each click to distribute information.

For the commodity with the same barcode, an information distributor C also inputs through an information distributing terminal the commodity name or barcode information, for example, commodity name: Grapefruit Juice of DAHU Brand, barcode information: 690818338989; the information for distribution is: price: [symbol] 8.20 yuan, buy five bottles get one bottle of Orange Juice of DAHU free; and payment for each click is set as: [symbol] 0.38 yuan for each click to distribute information.

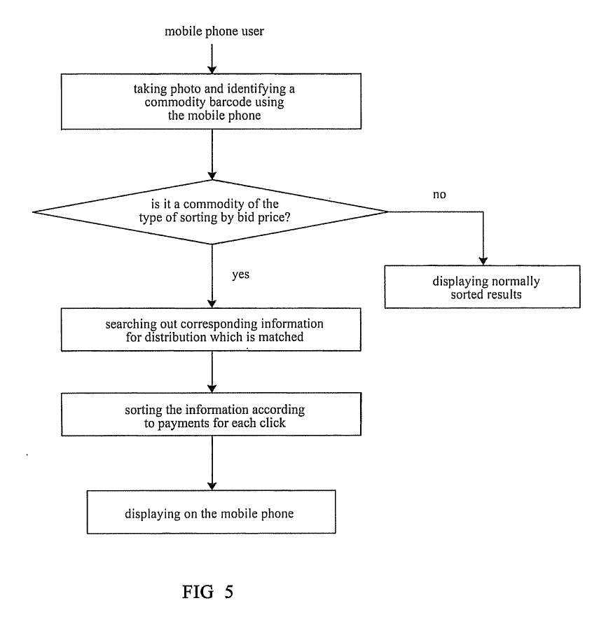

FIG. 5 is a schematic for information sorting. A mobile phone user reads and identifies a barcode such as Grapefruit Juice of DAHU Brand with barcode 6908180338989 on a commodity or its packaging through camera apparatus of a mobile phone; the system determine whether the commodity represented by the barcode is a commodity that should be sorted by bid price, if it is not, a general sorted result is displayed on the mobile phone; if it is a commodity that should be sorted by bid price, the system obtains matched information for distribution from stored information, for example:

the information distributor A: price: [symbol] 8.00 yuan, buy five get one free, free delivery within the fourth ring road of Beijing;

the information distributor B: price: [symbol] 7.80 yuan, buy six get one free, raffle promotions for users in Beijing; and

the information distributor C: price: [symbol] 8.20 yuan, buy five bottles get one bottle of Orange Juice of DAHU free.

The system sorts the above information according to payments for each click. For example, payment for each click is [symbol] 0.3 yuan for the information distributor A, [symbol] 0.35 yuan for the information distributor B, and [symbol] 0.37 yuan for the information distributor C. The sorting rule of the sorting system is descending from information with higher price to information with lower price. In this case, the information with price of [symbol] 0.37 yuan is sorted as the first one, the information with price of [symbol] 0.35 yuan is sorted as the second one and the information with price of [symbol] 0.35 yuan is sorted as the third one. As such, the order of displaying on the mobile phone is as follow:

the information distributor C: price: [symbol] 8.20 yuan, buy five bottles get one bottle of Orange Juice of DAHU free;

the information distributor B: price: [symbol] 7.80 yuan, buy six get one free, raffle promotions for users in Beijing; and

the information distributor A: price: [symbol] 8.00 yuan, buy five get one free, free delivery within the fourth ring road of Beijing.

If there are two or more pieces of information with same price, or there is information that is not of the type of sorting by bid price, any one of the following six sorting schemes may be employed:

1. sorting by submitting time of each information distributor, and information with earlier submitting time preceding information with later submitting time;

2. sorting by submitting time of each information distributor, and information with earlier submitting time following information with later submitting time;

3. sorting by verified time of information submitted by each information distributor, and information with earlier verified time preceding information with later verified time;

4. sorting by verified time of information submitted by each information distributor, and information with earlier verified time following information with later verified time;

5. for commodity information containing price information, information with lower price preceding information with higher price;

6. random sorting.

### Example 2

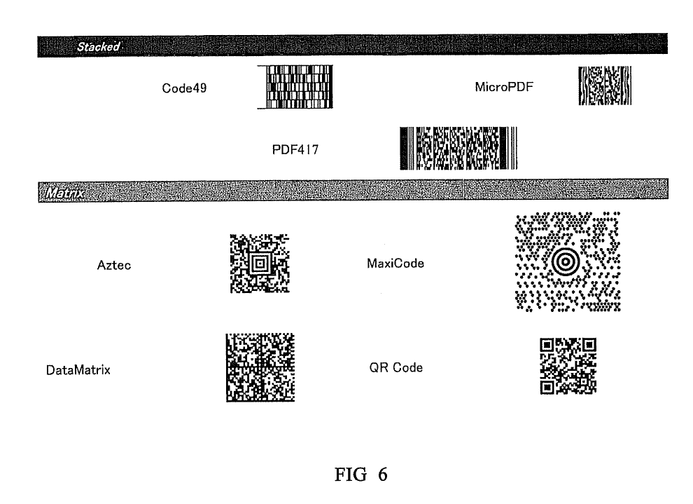

Referring to FIG. 6, based on example 1, example 2 is to replace the EAN barcodes with two-dimensional barcodes. A two-dimensional barcode may carry more amount of information compared to a one-dimensional barcode, and has better error tolerance capacity to facilitate identification by a mobile phone with a camera apparatus.

In example 2, a two-dimensional barcode may be encoded and written as an information barcode or an advertisement barcode, and the carrying medium of the barcode may be paper, plastic, chinaware, or may be a displaying terminal such as LCD, PDP, projector and so on (including TV set).

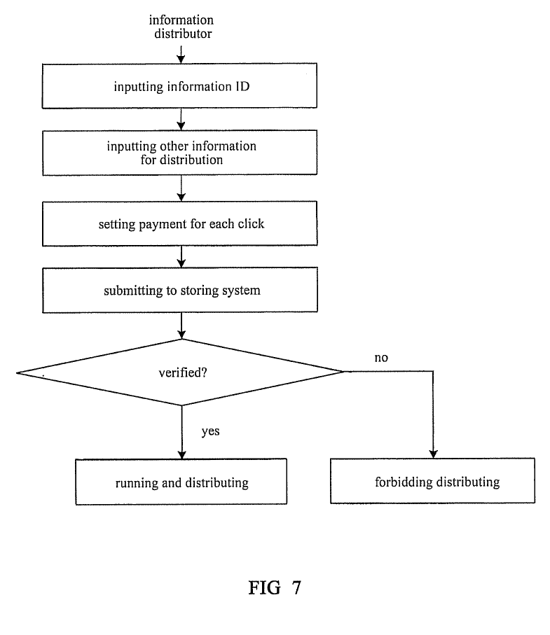

The flow for information distributing of example 2 is substantially the same as that of example 1, except that for the first step, an information distributor may input an information ID of the two-dimensional barcode (for example, 200345), other than inputting a barcode or name of a commodity. Other steps are the same as that of example 1, as shown in FIG. 7.

The flow for information sorting is the same as that of example 1, except for replacing the commodity barcode with a two-dimensional barcode.

In example 2, a two-dimensional barcode may be encoded into an information ID such as 200345 or an URL such as http://wap.gmedia.cn/200345, which connects a mobile phone to the URL http://wap.gmedia.cn/200345, and an ordering of information for distribution of information distributors is displayed on this page. For example, a two-dimensional barcode directs a user to query information about Sichuan food, then after identifying the barcode and connecting to a network, the displayed ordering is:

South Beauty Beihai Wantai Store, Phone: 62343234;

Yu Xiang Ren Jia: Haidian Book City Store, Phone: 63546387;

Fei Teng Yu Xiang: Scitech Plaza Store, Phone: 64352834.

Because the payment for each click set by South Beauty is the highest, it is ordered as the first one. Since the payment for each click set by Fei Teng Yu Xiang is the lowest, it is ordered as the last one.

### Example 3

Based on example 1 or 2, example 3 is to replace the mobile communication terminal with a palm with a wireless network card, and to replace the communication network with a network based on wireless communication base stations and wireless network card, while other steps remain the same.

1-14. (canceled)

15. A method of collecting and distributing information and sorting by bid price, the method comprising:
generating a barcode including commodity-related information;
inputting information for distribution via an information inputting terminal to a distributing server and setting payment for each click by an information distributor;
associating the barcode information with the information for distribution in the distributing server;
reading the barcode on an information carrier and initiating a request for search with a wireless communication terminal;
in response to receiving the request via a network, searching for at least one piece of information for distribution associated with the barcode by the distributing server;
sorting the searched information for distribution according to the set payment for each click as a sorted result set by the distributing server; and
sending the sorted result set to the wireless communication terminal and displaying.

16. The method of collecting and distributing information and sorting by bid price in claim 15, wherein the operation of initiating a request for search further comprises:
decoding and translating the barcode into an ID associated with at least one search keyword and
sending the ID to the distributing server, and the operation of searching is performed according to the at least one search keyword.

17. The method of collecting and distributing information and sorting by bid price in claim 15, wherein the sorting scheme comprises information for distribution with higher payment preceding information with lower payment, and if there are two or more information with the same payment, the sorting scheme further comprises one selected from the following:
1) sorting by submitting time of each information distributor, and information with earlier submitting time preceding information with later submitting time;
2) sorting by submitting time of each information distributor, and information with earlier submitting time following information with later submitting time;
3) sorting by verified time of information submitted by each information distributor, and information with earlier verified time preceding information with later verified time;
4) sorting by verified time of information submitted by each information distributor, and information with earlier verified time following information with later verified time;
5) with respect to information for distribution containing price, information with lower price preceding information with higher price; and
6) random sorting.

18. The method of collecting and distributing information and sorting by bid price in claim 15, wherein the barcode comprises an URL, and the method further comprises:
directing the wireless communication terminal to a page by the URL, and
displaying the sorted result set on the page.

19. The method of collecting and distributing information and sorting by bid price in claim 15, wherein the network is selected from a group consisting of a mobile communication network, a wireless local area network, and a wireless internet.

20. A system of collecting and distributing information and sorting by bid price, the system comprising:
a wireless communication terminal with an information reading apparatus to read a barcode on an information carrier carrying commodity-related information and to initiate a request for search;
an information inputting terminal to collect information for distribution which is associated with the barcode information and payment for each click set by an information distributor;
an information distributing server to store the information for distribution;
a searching module within the information distributing server to search for at least one piece of information for distribution associated with the barcode in response to receiving the request for search via a network;
a sorting module within the information distributing server to sort the searched information for distribution according to the set payment for each click as a sorted result set; and
a replying module within the information distributing server to send the sorted result set to the wireless communication terminal for being displaying on the wireless communication terminal.

21. The system of collecting and distributing information and sorting by bid price in claim 20, wherein the wireless communication terminal further comprises a decoding apparatus for decoding and translating the barcode into an ID associated with at least one search keyword and a responding apparatus for initiating the request for search by sending the ID to the information distributing server via the network.

22. The system of collecting and distributing information and sorting by bid price in claim 20, wherein the sorting module operates according to a sorting scheme of information for distribution with higher payment preceding information with lower payment, and if there are two or more information with the same payment, the sorting scheme further comprises one selected from the following:
1) sorting by submitting time of each information distributor, and information with earlier submitting time preceding information with later submitting time;
2) sorting by submitting time of each information distributor, and information with earlier submitting time following information with later submitting time;
3) sorting by verified time of information submitted by each information distributor, and information with earlier verified time preceding information with later verified time;
4) sorting by verified time of information submitted by each information distributor, and information with earlier verified time following information with later verified time;
5) with respect to information for distribution containing price, information with lower price preceding information with higher price; and
6) random sorting.

23. The system of collecting and distributing information and sorting by bid price in claim 20, wherein the barcode comprises an URL for directing the wireless communication terminal to a page, and the sorted result set is displayed on the page.

24. The system of collecting and distributing information and sorting by bid price in claim 20, wherein the network is selected from a group consisting of a mobile communication network, a wireless local area network, and a wireless internet.

25. The system of collecting and distributing information and sorting by bid price in claim 20, wherein the information reading apparatus is selected from a group consisting of a digital camera, a barcode identifying device, and a RFID reader/writer.

26. The system of collecting and distributing information and sorting by bid price in claim 20, wherein the information inputting system is selected from a group of a wireless inputting terminal and a computer terminal.

27. The system of collecting and distributing information and sorting by bid price in claim 20, wherein the wireless communication terminal is selected from a group of a mobile phone, a palm and other wireless communication devices.
